(19) United States
(12) Patent Application Publication
(10) Pub. No.: US 2026/0365340 A1
(43) Pub. Date: Nov. 19, 2026

(54) HIGH ENDURANCE AERODYNAMIC DRONE

(71) Applicant: Advanced Aircraft Company, Hampton, VA (US)

(72) Inventor: William Joseph Fredericks, Williamsburg, VA (US)

(21) Appl. No.: 19/682,059

(22) Filed: May 19, 2026

Related U.S. Application Data
(60) Provisional application No. 63/808,064, filed on May 19, 2025.

(51) Int. Cl. B64U 10/20; B64C 29/02; B64C 39/08; B64U 30/10; B64U 30/40; B64U 50/13; B64U 50/18; B64U 50/19

(52) U.S. Cl. CPC B64U 10/20; B64C 29/02; B64C 39/08; B64U 30/10; B64U 30/40; B64U 50/13; B64U 50/18; B64U 50/19

(57) ABSTRACT

An aircraft operable to transition between thrust-borne lift in a VTOL configuration and wing-borne lift in a flight configuration, the aircraft including an airframe having a first wing and a second wing that are each configured to have an airfoil cross-section that generates lift responsive to the forward air speed of the aircraft. The aircraft also includes a plurality of variable speed electric propulsion assemblies having fixed pitch rotor blades and fixed thrust vector capability; wherein each propulsion assembly includes a rotor assembly that is coupled to an output drive of a respective electrical motor that rotates the rotor assembly in a rotational plane. Each propulsion assemblies being positioned therein a respective propulsion assembly pylon of the first and second wings such that the angle of thrust of each of the propulsion assemblies forms a compound angle.

### REFERENCE TO RELATED APPLICATIONS

The present Patent Application claims benefit of U.S. Provisional Patent Application No. 63/808,064, filed May 19, 2025.

### INCORPORATION BY REFERENCE

U.S. Provisional Patent Application No. 63/808,064, filed May 19, 2025, is specifically incorporated by reference herein as if set forth in its entirety.

### TECHNICAL FIELD

The present disclosure relates generally to the field of unmanned arial vehicles, also known as “drones,” and, more particularly, the invention relates to a drone having enhanced aerodynamic efficiency that allows for enhanced operational range, endurance, and speed.

### BACKGROUND

As one will appreciate, a wide range of applications exist for drones. In general, conventional drones can include fixed-wing drones that are capable of flight using wings that generate lift responsive to the forward air speed of the drone, which is generated by thrust from one or more jet engines or propellers. The wings generally have an airfoil cross section that deflects air downward as the drone moves forward, generating the lift force to support the airplane in flight. Fixed-wing drones, however, typically require a runway having extended length for conventional takeoff and landing, or catapults and catch mechanisms, or can be “hand launched.”

Alternatively, conventional drones can include vertical takeoff and landing (“VTOL”) drone designs are configured to takeoff, hover and land in a substantially vertical manner and thus to operate in the takeoff and landing modes without the use of an extended length runway. Optionally, conventional VTOL drones have included tiltrotor and/or tiltwing design concepts to generate the desired VTOL flight characteristics. For example, tiltrotor drones are typically configured to generate lift and propulsion using proprotors that are coupled to nacelles mounted near the ends of a fixed wing. In operation, the nacelles are configured to rotate relative to the fixed wing such that the proprotors have a generally horizontal plane of rotation for vertical takeoff hovering and landing and a generally vertical plane of rotation for forward flight. Similarly, tiltwing drones are typically configured with a rotatable wing that is generally positioned horizontal for forward flight and then is rotated to a generally vertical orientation for vertical takeoff and landing. In operation, propellers are coupled to the rotatable wing to provide the required vertical thrust for takeoff and landing and the required forward thrust to generate lift from the wing during forward flight.

As VTOL drone designs evolve, specifically multi-copter, quad-copter, etc. the basic parts of the drone and the attendant problems remain the same. A drone is basically a flying minicomputer, where the flight time or flight endurance is conventionally determined by the capacity of the battery, the weight of the drone, the weight of the payload (camera, sensor, package, munition, etc.), and how fast the drone flies. While these noted factors are important to the overall flight time endurance of the VTOL drone, the flight aerodynamics of these multi-copter drones is an overlooked factor that can create a significant increase in the overall endurance level of the drone.

There is a need, therefore, to create a much more aerodynamically efficient drone that wastes less energy throughout the conventional VTOL flight profile than is available via prior art drones. The current invention provides just such a solution by providing a fixed-wing drone that relies on improved flight aerodynamics, an improved wing design, and engine orientation to move the drone throughout the desired flight profile more efficiently that is presently allowed by the prior art.

### SUMMARY

To improve the state of the art, disclosed herein is a fixed-wing VTOL drone operable to transition between thrust-borne lift in a VTOL orientation and wing-borne lift in a biplane orientation. The VTOL drone includes an airframe having first and second wings coupled to an elongated airframe, a plurality of propulsion assemblies coupled to the first wing, and a plurality of propulsion assemblies coupled to the second wing. A flight control system is contained within the airframe and is operable to independently control each of the propulsion assemblies.

In embodiments, in the biplane orientation, the first wing can be configured as an opposing pair of upper wings that are positioned in a dihedral configuration and the second wing can be configured as an opposing pair of lower wings that are positioned in a combination anhedral and dihedral configuration. In further embodiments, it is contemplated that the first and second wings can be configured with sweep and twist configurations.

In embodiment, the aircraft is configurable to be operable to transition between thrust-borne lift in a VTOL configuration and wing-borne lift in a flight configuration. Generally the aircraft can include an airframe having a first wing and a second wing that are each configured to have an airfoil cross-section that generates lift responsive to the forward airspeed of the aircraft. In one aspect, each wing includes include a pair of propulsion assembly pylons, a root wing section, an inboard wing section, and an outboard wing section that are configured to increase the aerodynamic efficiency and flight dynamics of the aircraft. In this aspect, the root wing section of each wing is coupled to and extends outwardly from the airframe to a distal end that is coupled to a proximal end of the inboard wing section. Further, the distal end of the inboard wing section is coupled to an inboard side of one propulsion assembly pylon and a proximal end of the outboard wing section is coupled to and extends outwardly from an outboard side of the propulsion assembly pylon

The first wing and the second wing can be positioned with respect to each other in a biplane orientation in which the first wing is positioned forward of the second wing that is positioned at a distal end portion of the airframe. In this aspect, the first wing can form an upper wing having a general dihedral configuration and the second wing can form a lower wing in which the inboard wing section has an anhedral configuration and the outboard wing section has a dihedral configuration.

The aircraft can further include a plurality of variable speed electric propulsion assemblies having fixed pitch rotor blades and fixed thrust vector capability. In this aspect, each propulsion assembly includes a rotor assembly that is coupled to an output drive of a respective electrical motor that rotates the rotor assembly in a rotational plane to generate thrust for the aircraft. Further, it is contemplated that the propulsion assemblies is positioned therein a respective propulsion assembly pylon of the first and second wings such that the angle of thrust of each of the propulsion assemblies forms a compound angle.

Still other aspects, embodiments, and advantages of these exemplary aspects and embodiments, are discussed in detail below. Moreover, it is to be understood that both the foregoing information and the following detailed description are merely illustrative examples of various aspects and embodiments and are intended to provide an overview or framework for understanding the nature and character of the claimed aspects and embodiments. Accordingly, these and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain the principles of the embodiments discussed herein. No attempt is made to show structural details of this disclosure in more detail than can be necessary for a fundamental understanding of the exemplary embodiments discussed herein and the various ways in which they can be practiced. According to common practice, the various features of the drawings discussed below are not necessarily drawn to scale. Dimensions of various features and elements in the drawings can be expanded or reduced to more clearly illustrate the embodiments of the disclosure.

FIGS. 1A – 1D are schematic illustrations of an aircraft operable to transition between thrust-borne lift in a VTOL orientation and wing-borne lift in a biplane orientation in accordance with embodiments of the present disclosure.

FIGS. 2A – 2E are schematic illustrations of the first and second wings of the aircraft of FIGS. 1A – 1D in accordance with embodiments of the present disclosure.

FIGS. 3A – 3E are schematic illustrations of the compound angle thrust vectors of the propulsion assemblies of the aircraft of FIGS. 1A – 1D in accordance with embodiments of the present disclosure.

FIG. 4 is a block diagram of one implementation of a thrust array and a flight control system for an aircraft in accordance with embodiments of the present disclosure.

FIG. 5 is a block diagram of autonomous and remote control systems for an aircraft in accordance with embodiments of the present disclosure.

### DETAILED DESCRIPTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a wing” can include two or more such wings unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It should be appreciated, that as used herein, terms of approximation, such as a “about” or “approximately,” refers to being within 10% margin of error.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “can,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular embodiment.

The phraseology and terminology used herein is for the purpose of description and should not be regarded as limiting. As used herein, the term "plurality" refers to two or more items or components. The terms "comprising," "including," "carrying," "having," "containing," and "involving," whether in the written description or the claims and the like, are open-ended terms, i.e., to mean "including but not limited to." Thus, the use of such terms is meant to encompass the items listed thereafter, and equivalents thereof, as well as additional items. Only the transitional phrases "consisting of" and "consisting essentially of," are closed or semi-closed transitional phrases, respectively, with respect to any claims. Use of ordinal terms such as "first," "second," "third," and the like in the claims to modify a claim element does not by itself connote any priority, precedence, or order of one claim element over another or the temporal order in which acts of a method are performed but are used merely as labels to distinguish one claim element having a certain name from another element having a same name (but for use of the ordinal term) to distinguish claim elements.

In the specification, reference can be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein can be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the device described herein can be oriented in any desired direction. As used herein, the term “coupled” can include direct or indirect coupling by any means, including moving and/or non-moving mechanical connections.

Disclosed are components that can be used to perform the disclosed methods and systems. These and other components are disclosed herein, and it is understood that when combinations, subsets, interactions, groups, etc. of these components are disclosed that while specific reference to each various individual and collective combinations and permutation of these cannot be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems can be understood more readily by reference to the following detailed description of preferred embodiments and the examples included therein and to the Figures and their previous and following description.

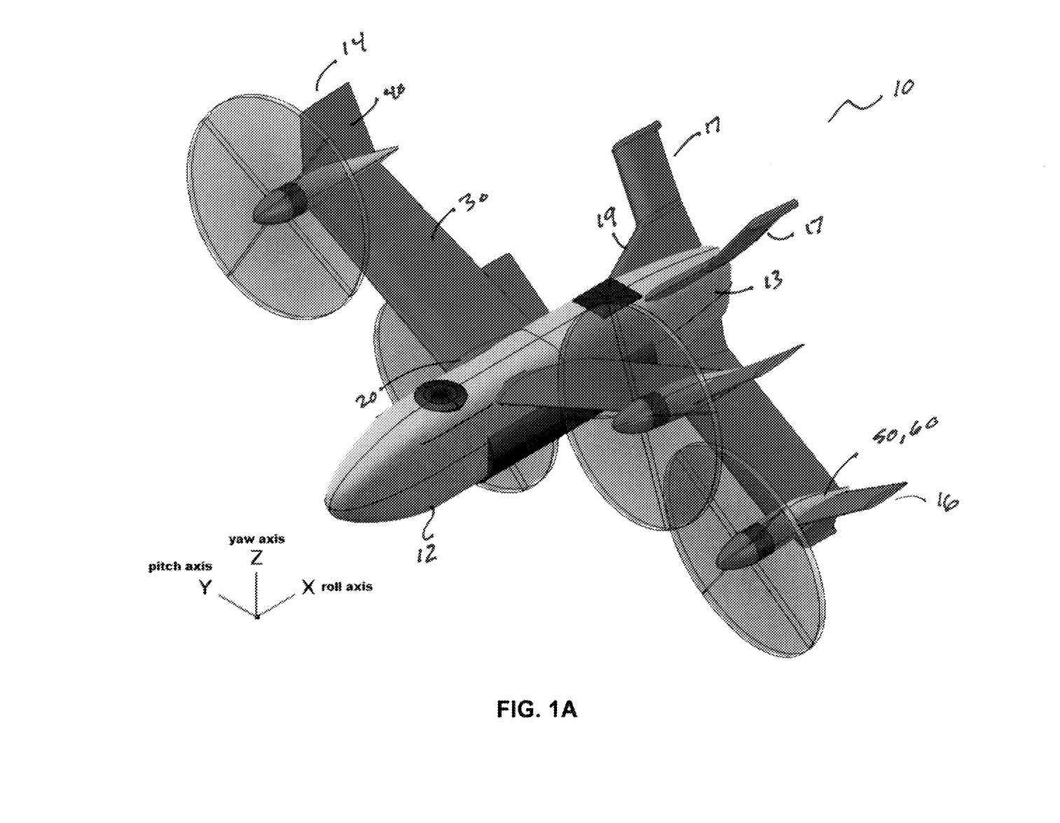

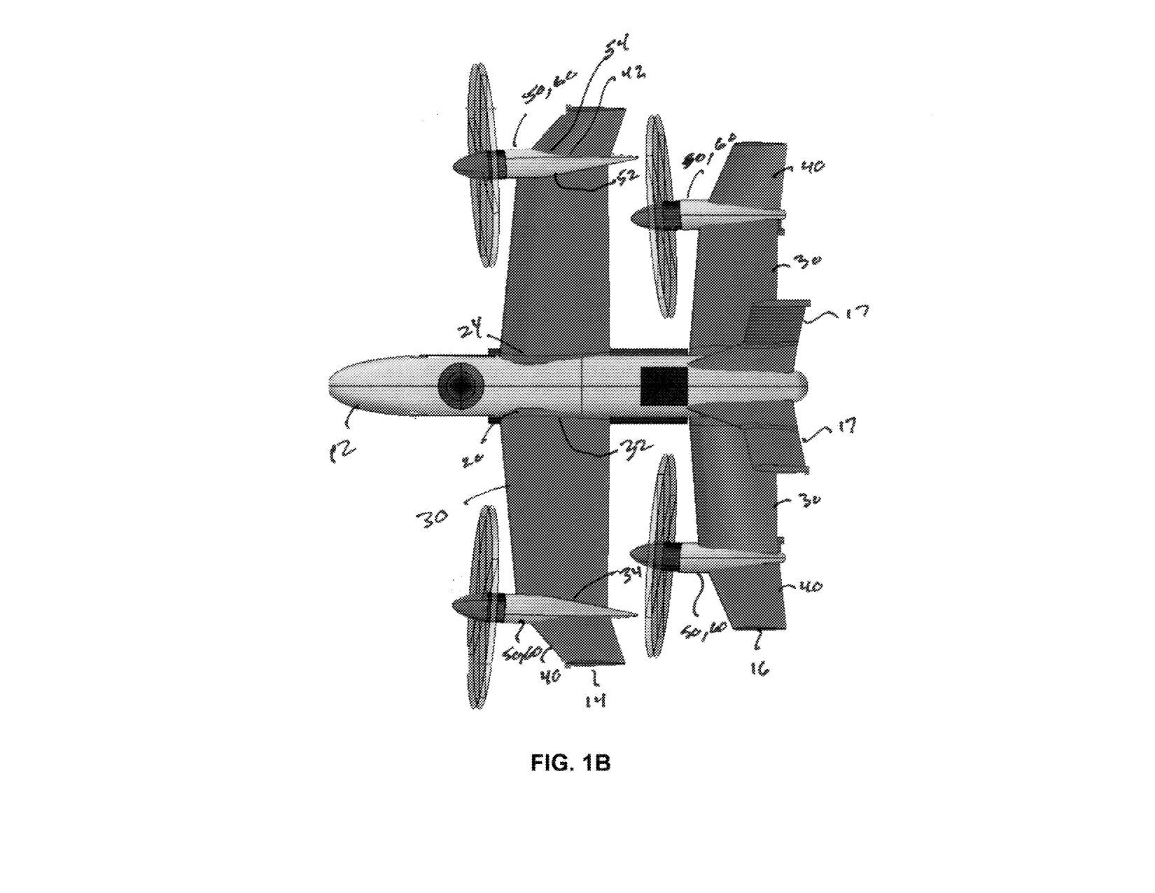

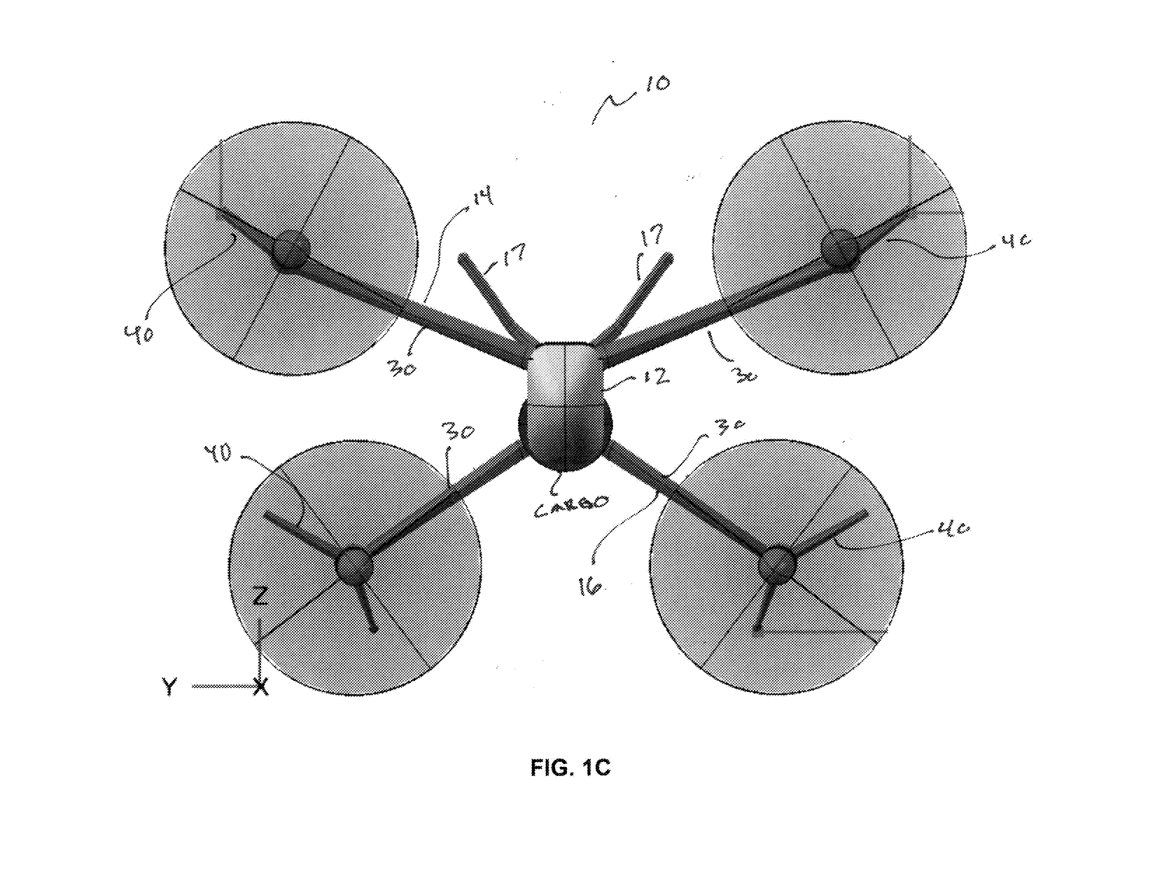

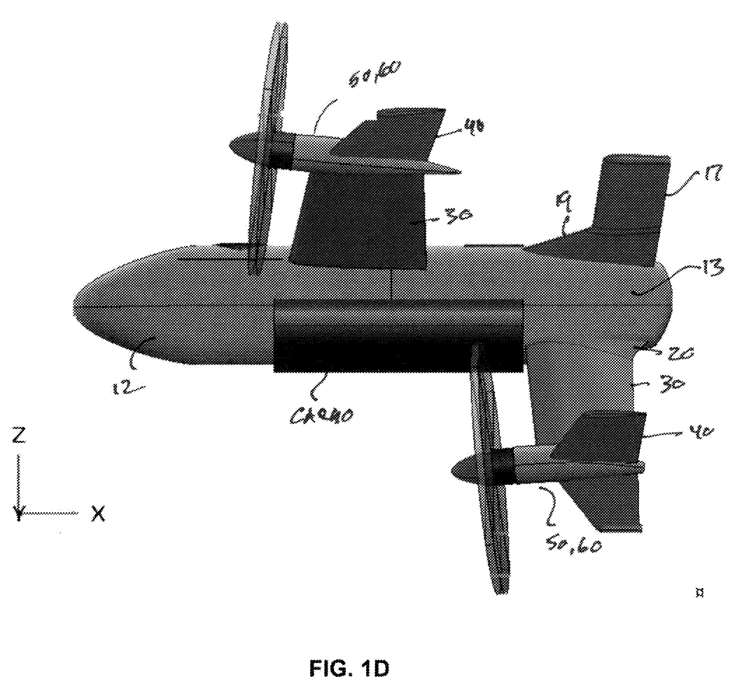

Referring to FIGS. 1A-1D, various views of an aircraft 10 operable to transition between thrust-borne lift in a VTOL orientation and wing-borne lift in a biplane orientation are depicted. When the aircraft 10 is positioned in the VTOL orientation, the propulsion assemblies of the aircraft provide thrust-borne lift. Similarly, FIGS. 1A – 1D and 2A – 2E depict the aircraft 10 in a biplane orientation wherein the propulsion assemblies of the aircraft provide forward thrust with the forward airspeed of aircraft 10 providing wing-borne lift, which enables aircraft 10 to have a high speed, high endurance, and/or long range forward flight mode. Aircraft 10 has a longitudinal axis 10a that extends through the Center of Gravity (“CG”) of the axis and that can also be referred to as the roll axis. Aircraft 10 further has a lateral axis 10b that can also be referred to as the pitch axis and a vertical axis 10c that can also be referred to as the yaw axis, as shown in the figures.

In embodiments, the aircraft 10 includes an airframe 12 including wings, particularly a first wing 14 and a second wing 16, that are each configured to have an airfoil cross-section that generates lift responsive to the forward airspeed of aircraft 10. As shown and described in more detail below, it is contemplated that each wing 14, 16 is formed from multiple wing sections that are configured to increase the aerodynamic efficiency and flight dynamics of the aircraft. In embodiments, it is contemplated that each wing 14, 16 will include a root wing section 20, an inboard wing section 30, and an outboard wing section 40. The root wing section 20 of each wing is coupled to and extends outwardly therefrom airframe 12 to a distal end 24 that is coupled to a proximal end 32 of the inboard wing section 30. The distal end 34 of the inboard wing section is coupled to an inboard side 52 of a propulsion assembly pylon 50 and a proximal end 42 of the outboard wing section 40 is coupled to and extends outwardly there from an outboard side 54 of the propulsion assembly pylon 50.

As shown in the figures, It is contemplated that the wings 14, 16 can be positioned with respect to each other in a biplane orientation in which wing 14 is positioned forward of wing 16, which is positioned at a distal end portion 13 of airframe 12. Thus as shown, in embodiments, wing 14 is an upper wing having a general dihedral configuration and wing 16 is a lower wing in which separate portions of the wing has an anhedral configuration and a dihedral configuration.

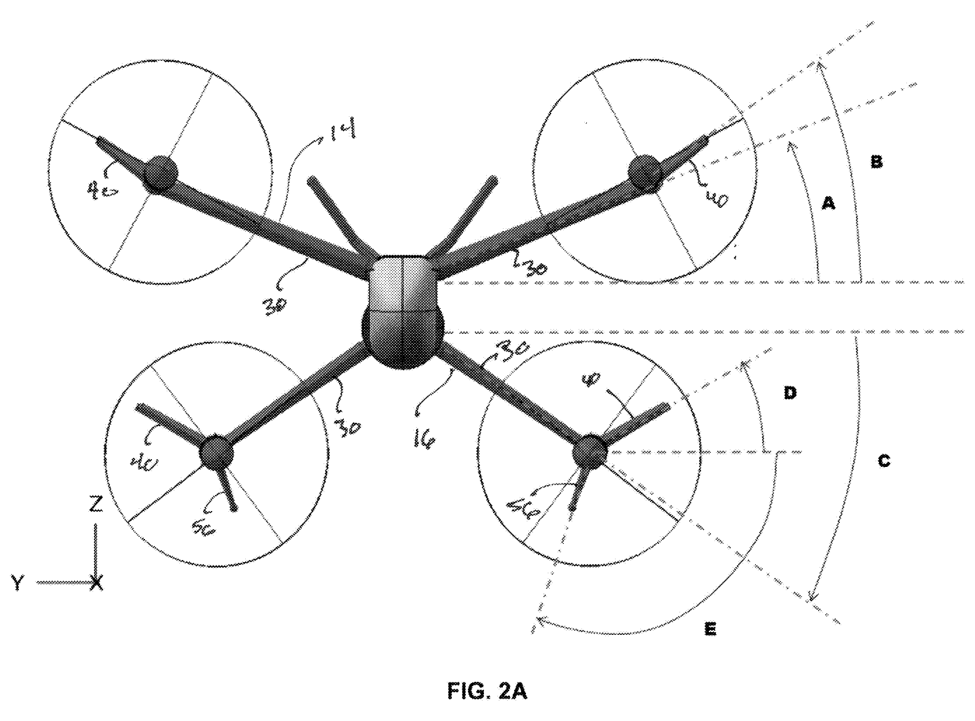

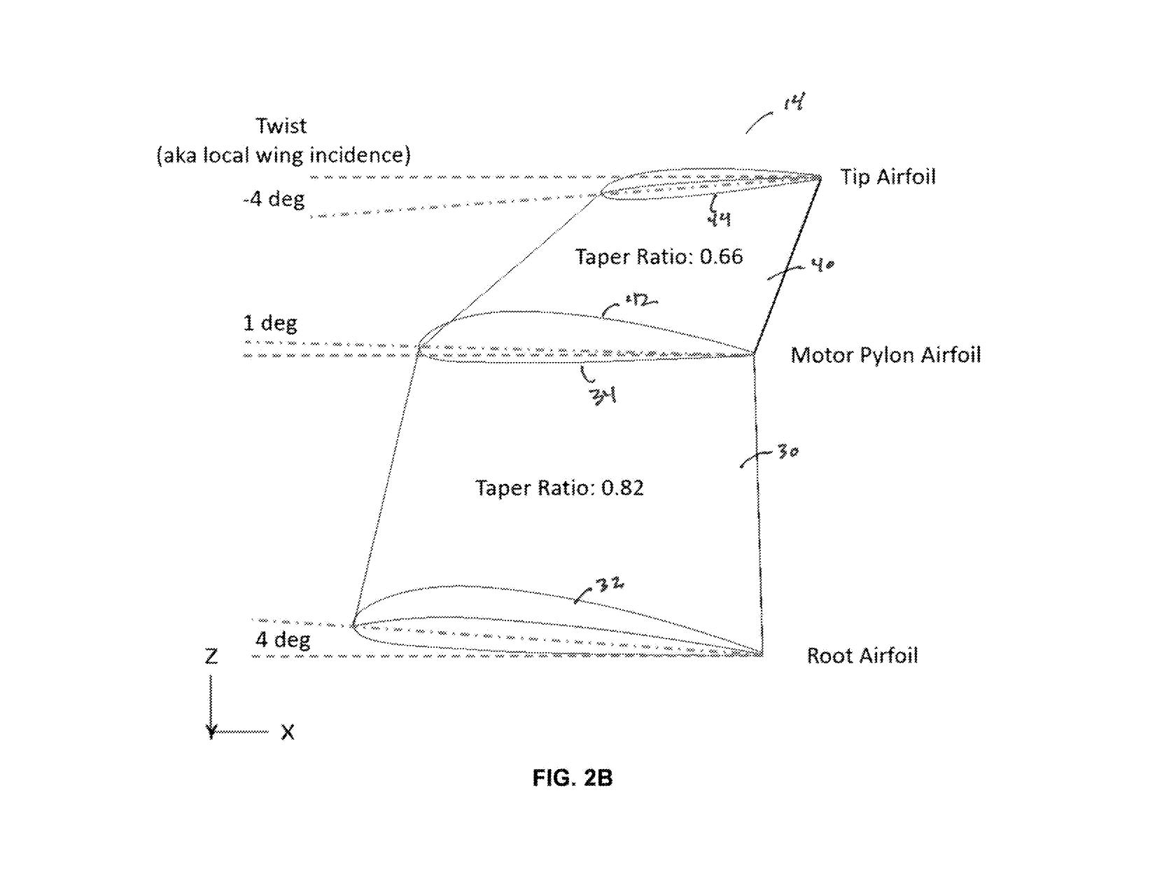

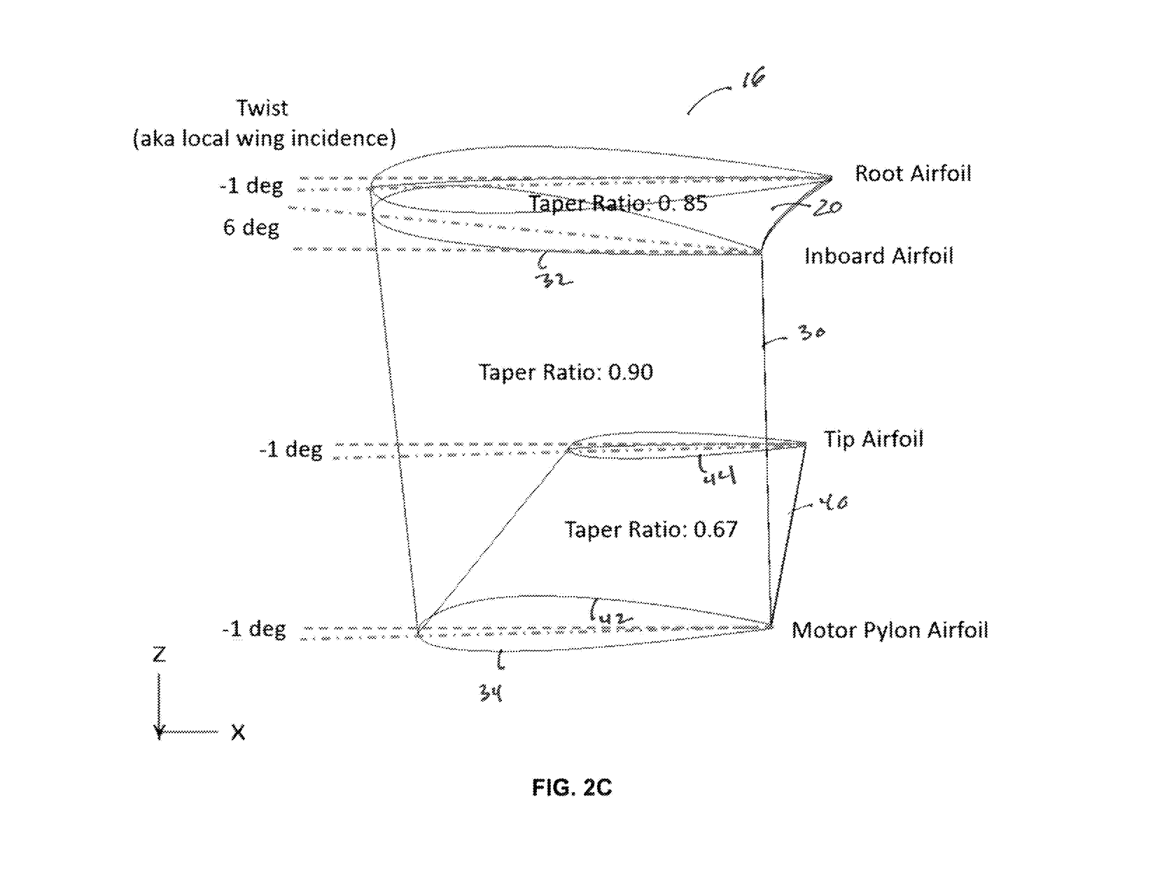

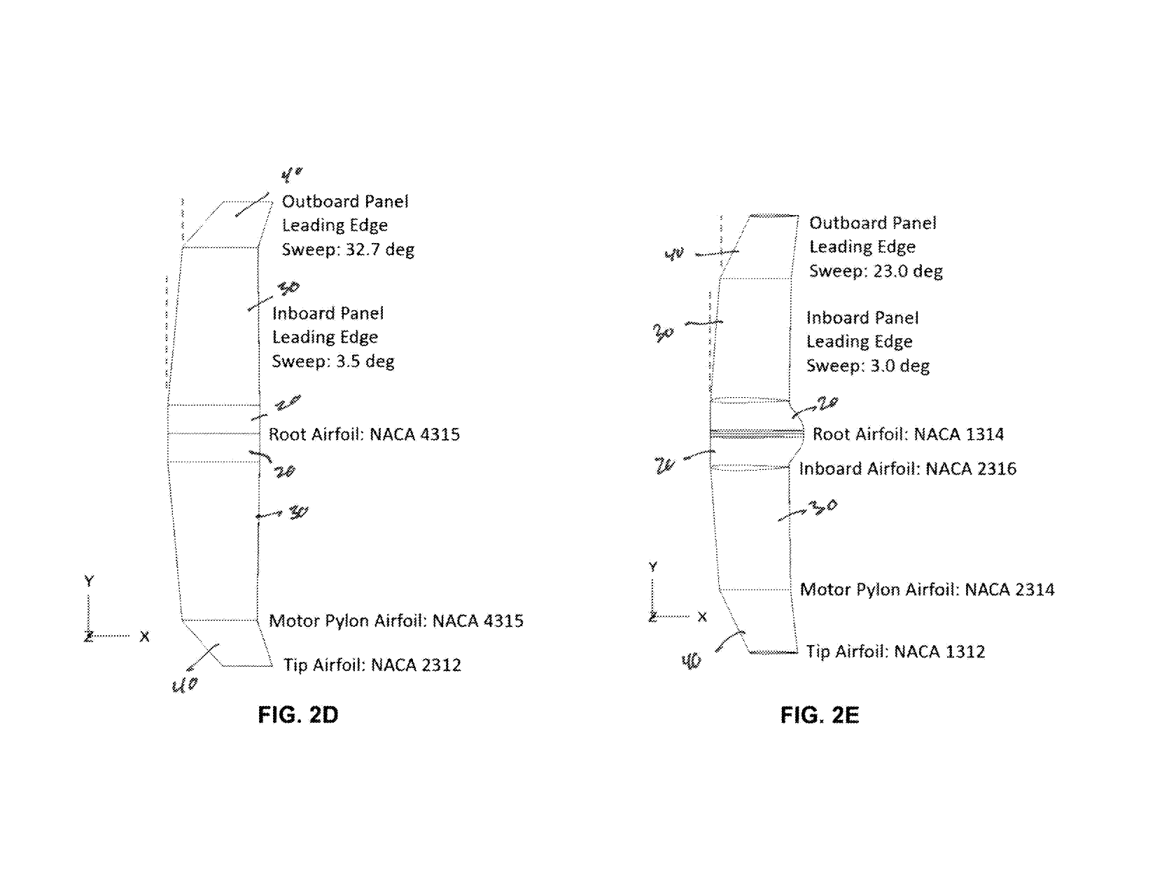

As shown in FIG. 2A, it is contemplated that the inboard wing section 30 of wing 14 can be positioned at a dihedral angle A with respect to a plane parallel to the pitch axis 10a of the aircraft. In the illustrated embodiment, the dihedral angle A of the inboard wing section of wing 14 can be between about 10 degrees and about 30 degrees, more preferably between about 15 degrees and about 25 degrees, and most preferred about 22 degrees. As further shown, it is contemplated that the outboard wing section 40 of wing 14 can be positioned at a dihedral angle B with respect to a plane parallel to the pitch axis 10a of the aircraft. In this aspect, the dihedral angle B of the outboard wing section of wing 14 can be between about 25 degrees and about 50 degrees, more preferably between about 35 degrees and about 45 degrees, and most preferred about 40 degrees.

As shown in FIG. 2A, it is contemplated that the inboard wing section of wing 16 can be positioned at an anhedral angle C with respect to a plane parallel to the pitch axis 10a of the aircraft. In the illustrated embodiment, the anhedral angle C of the inboard wing section of wing 16 can be between about -25 degrees and about -45 degrees, more preferably between about -30 degrees and about -40 degrees, and most preferred about -34 degrees. As further shown, it is contemplated that the outboard wing section of wing 16 can be positioned at a dihedral angle D with respect to a plane parallel to the pitch axis 10a of the aircraft. In this aspect, the dihedral angle D of the outboard wing section of wing 14 can be between about 20 degrees and about 40 degrees, more preferably between about 25 degrees and about 35 degrees, and most preferred about 30 degrees.

In a further embodiment, wing 16 can further include a landing form 56 coupled to and extending outwardly from the propulsion assembly pylon 50 at an anhedral angle E with respect to a plane parallel to the pitch axis 10a of the aircraft. In the illustrated embodiment, the anhedral angle E of the landing form 56 can be between about -85 degrees and about -135 degrees, more preferably between about -100 degrees and about -120 degrees, and most preferred about -110 degrees. In this aspect, it is contemplated that a rearward facing portion of the landing form 58 can be configured with a planar surface that is suitable for ground contact and is sized to help prevent tip over of the aircraft during takeoff and landing VTOL operations.

In other embodiments, inboard wing section 30 of wing 14 can have a sweep angle from the proximal end 32 to the distal end 34 of inboard wing section 30 of between about 0 degrees and about 6 degrees, more preferably between about 2 degrees and about 5 degrees, and most preferred about 3.5 degrees. Further, the outboard wing section 40 of wing 14 can have a sweep angle from the proximal end 42 to the distal end 44 of outboard wing section 40 of between about 20 degrees and about 40 degrees, more preferably between about 27.5 degrees and about 37.5 degrees, and most preferred about 32.7 degrees.

Similarly, in other embodiments, inboard wing section 30 of wing 16 can have a sweep angle from the proximal end 32 to the distal end 34 of inboard wing section 30 of between about -15 degrees and about 15 degrees, more preferably between about -5 degrees and about 10 degrees, and most preferred about 3 degrees. Further, the outboard wing section 40 of wing 16 can have a sweep angle from the proximal end 42 to the distal end 44 of outboard wing section 40 of between about 15 degrees and about 32 degrees, more preferably between about 19 degrees and about 27 degrees, and most preferred about 23 degrees.

In other embodiments, inboard wing section 30 of wing 14 can have a taper ratio from the proximal end 32 to the distal end 34 of the inboard wing section 30 of between about 0.70 and about 0.90, more preferably between about 0.78 and about 0.85, and most preferred about 0.82. Further, the outboard wing section 40 of wing 14 can have a taper ratio from the proximal end 42 to the distal end 44 of the outboard wing section 40 of between about 0.55 and about 0.75, more preferably between about 0.60 and about 0.70, and most preferred about 0.66.

Similarly, in other embodiments, inboard wing section 30 of wing 16 can have a taper ratio from the proximal end 32 to the distal end 34 of the inboard wing section 30 of between about 0.80 and about 0.96, more preferably between about 0.85 and about 0.93, and most preferred about 0.90. Further, the outboard wing section 40 of wing 14 can have a taper ratio from the proximal end 42 to the distal end 44 of the outboard wing section 40 of between about 0.55 and about 0.75, more preferably between about 0.60 and about 0.70, and most preferred about 0.67.

In other embodiments and referring to FIGS. 2B and 2C, the inboard wing section 30 of wing 14 can have local wing incidence (“”twist”) from the proximal end 32 to the distal end 34 of the inboard wing section 30 that changes from about 4 degrees proximate the junction of the inboard wing section 30 to the root section 20 to about 1 degree at the junction of the distal end 34 of the inboard wing section 30 and the inboard side 52 of a propulsion assembly pylon 50. Similarly, the outboard wing section 40 of wing 14 can twist from the proximal end 4 to the distal end 44 of the outboard wing section 40 that changes from about 1 degrees proximate the junction of the proximal end of the outboard wing section 30 to outboard side 54 of the propulsion assembly pylon 50 to about -4 degree at the distal end 44 the outboard wing section 30.

In other embodiments and referring to FIGS. 2B and 2C, the inboard wing section 30 of wing 16 can have twist from the proximal end 32 to the distal end 34 of the inboard wing section 30 that changes from about 6 degrees proximate the junction of the inboard wing section 30 to the distal end 24 of the root section 20 to about -1 degree at the junction of the distal end 34 of the inboard wing section 30 and the inboard side 52 of a propulsion assembly pylon 50. Similarly, the outboard wing section 40 of wing 16 can twist from the proximal end 42 to the distal end 44 of the outboard wing section 40 that changes from about -1 degrees proximate the junction of the proximal end of the outboard wing section 40 to outboard side 54 of the propulsion assembly pylon 50 to about -2 degree at the distal end 44 the outboard wing section 40. Optionally, and as shown, it is contemplated that the outboard wing section 40 of wing 16 can have de minimus twist.

In embodiments, the outer skins for wings 14, 16 can preferably be formed from high strength and lightweight materials such as fiberglass, carbon fiber, plastic (including 3D printed plastic), metal or other suitable material or combination of materials. Similarly, it is contemplated that propulsion assembly pylons 50 can be preferably formed from high strength and lightweight materials such as fiberglass, carbon, plastic, metal or other suitable material or combination of materials

In exemplary optional embodiments for wing 14 of the aircraft and referring to FIG. 2D, it is contemplated that the root section 20 can have a NACA 4315 airfoil cross-section, the inboard wing section 20 can have a NACA 2316 airfoil cross-section, and the outboard wing section 30 can have a NACA 2312 airfoil cross-section. Similarly, the propulsion assembly pylon 50 for wing 14 can have a NACA 4315 airfoil cross-section.

Similarly and for exemplary optional embodiments for wing 16 of the aircraft and referring to FIG. 2E, it is contemplated that the root section 20 can have a NACA 1314 airfoil cross-section, the inboard wing section 20 can have a NACA 2316 airfoil cross-section, and the outboard wing section 30 can have a NACA 1312 airfoil cross-section. Similarly, the propulsion assembly pylon 50 for wing 14 can have a NACA 2314 airfoil cross-section.

Each wing 14, 16 is configured to improve the stall characteristics of the aircraft. As shown, wings 14 and 16 are designed to have a smooth progressively increasing region of separated airflow (e.g., stalled region) as the relative angle of attack (AoA) of the airframe 12 increases. With the noted design configuration, stall happens first at the root and the trailing edge, and as angle of attack continues to increase, a generated stall region expands forward toward the leading edge and outboard in a progressively increasing area as AoA increases. The sweep of wing 14 also help ensure that the stall forms inboard first and progressively expands outboard as the AoA continues to increase.

One will appreciate that the disclosed twist, taper, changes in airfoil camber line, and/or sweep in the exemplified wings 14, 16 provides for the generation of a progressive trailing edge stall, which reduces the discontinuities in aerodynamic forces and moments as a function of angle of attack during the stall break.

The airframe further includes two opposed vertical tails 17 positioned there on the distal portion of the airframe 12, which are incorporated to improve directional stability at high angle of attack and are canted outboard relative to each other such that the distal ends of the respective vertical tails is spaced farther apart than the proximal end of the respective vertical tails. As one skilled in the art will appreciate, airflow will separate from the upper surface of the fuselage of the airframe 12 at a high angle of attack. The illustrated twin opposed vertical tails 17, at a high angle of attack, ensures that at least a portion of the vertical tails 17 are maintained in clean inflow and can thereby maintain their effectiveness of providing directional stability. Additionally these vertical tails can be configured to contain twist to help to increase directional stability while minimizing intersection drag at the fuselage junction. In this aspect, at the airframe junction, the incidence angle can be trailing edge inboard by 2 degrees relative to the longitudinal axis of the aircraft, or a range of about 0 degrees to about 7 degrees depending on the convergence angle of the adjacent airframe surface. Subsequently, the planform section of the respective vertical tail 17 can contain 4 degrees of twist, or a range of about 1 degree to about 8 degrees of twist. In this embodiment, having the vertical tails rotated trailing edge outboard can act to increase the directional stability of the aircraft. Optionally, the design of the vertical tails 17 can include a strake 19 disposed in front of the respective leading edge of the respective vertical tail leading edge that is configured to generate a bound vortex in the airflow, which can operate to increase the angle of attack that the surface can achieve before the air separates from the surface.

In embodiments, for VTOL takeoff and landing operations, it is contemplated that the aircraft 10 can makes contact with the ground at 4 points. The landing form 56 coupled to and extending outwardly from the propulsion assembly pylon 50 of wing 16 are 2 of the points of contact. The rear facing surfaces of the distal end of the vertical tails 17 are two additional points of contact. These points of contact are designed to hold the aircraft at an about 85 degree pitch up angle. When hovering, the aircraft will be controlled to maintain about the 85 degree pitch up angle. Because the prop wash generated by the propulsion assemblies 60 acting over the wings 14, 16 will be creating lift, the nose of the aircraft must be pitched down about 5 degrees from zenith orientation to achieve steady state hover.

Conventionally, wings 14, 16 and the propulsion assembly pylon 50 preferably include internal passageways operable to contain flight control systems 100, energy sources 90, communication lines and other desired systems that are in operable communication with a flight control system 110 and at least one energy source. For example, it is contemplated that the airframe defines at least one internal cavity that are configured to house the flight control system 110 and the at least one energy source 90 of the aircraft 10. For example, the flight control system 110 preferably includes non-transitory computer readable storage media including a set of computer instructions executable by one or more processors for controlling the operation of aircraft 10. In this aspect, it is contemplated that the flight control system 110 can be implemented on one or more general-purpose computers, special purpose computers or other machines with memory and processing capability. For example, the flight control system 110 can include one or more memory storage modules including, but is not limited to, internal storage memory such as random access memory, non-volatile memory such as read only memory, removable memory such as magnetic storage memory, optical storage, solid-state storage memory or other suitable memory storage entity. Operationally, the flight control system 110 can be a microprocessor-based system operable to execute program code in the form of machine-executable instructions. In addition, the flight control system 110 can be selectively connectable to other computer systems via a proprietary encrypted network, a public encrypted network, the Internet or other suitable communication network that can include both wired and wireless connections.

For example, it is contemplated that the wings 14 and 16 include the use of wing spars having rectangular and/or square shaped cross-section. In this aspect, the rectangular and/or square shaped cross-section of the wing spars creates a wing spar with a larger bending moment of inertia and a larger polar moment of inertia, for a given airfoil thickness. Further, the rectangular and/or square shaped cross-section of the wing spars allows for the aerodynamic pitching moment from the secondary structure to be imparted into the wing spar primary structure, without the airfoil spinning. The wing spars can be extruded aluminum tubing, 3D printed aluminum, 3D printed plastic, machined aluminum, extruded carbon fiber or fiberglass tubing, filament wound carbon fiber or fiberglass tubing, laid up carbon fiber or fiberglass tubing. It is also contemplated that the wing spars could have geometric cross sectional shape that is not a rectangular or square shaped cross-sectional shape. Further, it is contemplated that each wing 14, 16 can include a plurality of wing spars. Optionally, it is contemplated that each wing 14, and 16 can be formed from a monocoque construction in which the skin itself is the primary load carrying structure. In this aspect, the wing spars are not required so the resulting monocoque wing structure is beneficially lighter in overall weight when compared to the wing spar construction.

The at least one energy source 90 can include one or more of electrical power sources 90’ such as, for example, one or more batteries 90”. In this example, the one or more batteries can be configured to supply electrical power to the flight control system 110 and to a distributed thrust array of aircraft 10.

In embodiments, the airframe 12, wings 14, 16 and the propulsion assembly pylon 50 contain a communication network that enables the flight control system 110 to communicate with the distributed thrust array of aircraft 10. As used herein, the term “distributed thrust array” refers to the use of multiple thrust generating elements each producing a portion of the total thrust output. The use of a “distributed thrust array” provides redundancy to the thrust generation capabilities of the aircraft including fault tolerance in the event of the loss of one of the thrust generating elements. In this aspect, it is contemplated each thrust generating element includes an electric propulsion assembly 60.

In the illustrated embodiment, two propulsion assemblies 60 are coupled to the propulsion assembly pylon 50 of wing 14 and two propulsion assemblies 24 are coupled to the propulsion assembly pylon 50 of wing 16. In the illustrated embodiment, propulsion assemblies 60 are variable speed electric propulsion assemblies having fixed pitch rotor blades and fixed thrust vector capability. Each propulsion assembly 60 includes a rotor assembly that is coupled to an output drive of a respective electrical motor 24 that rotates the rotor assembly in a rotational plane to generate thrust for aircraft 10.

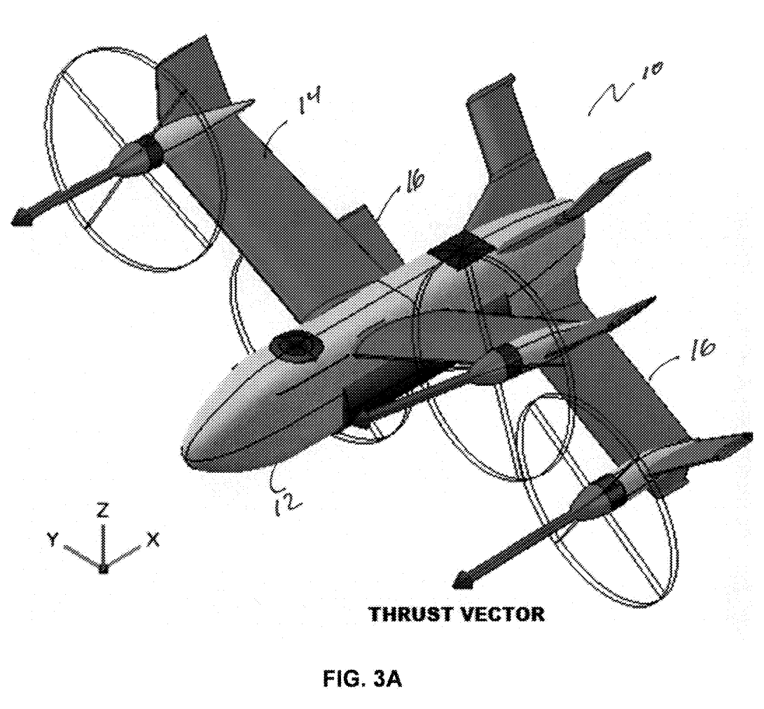

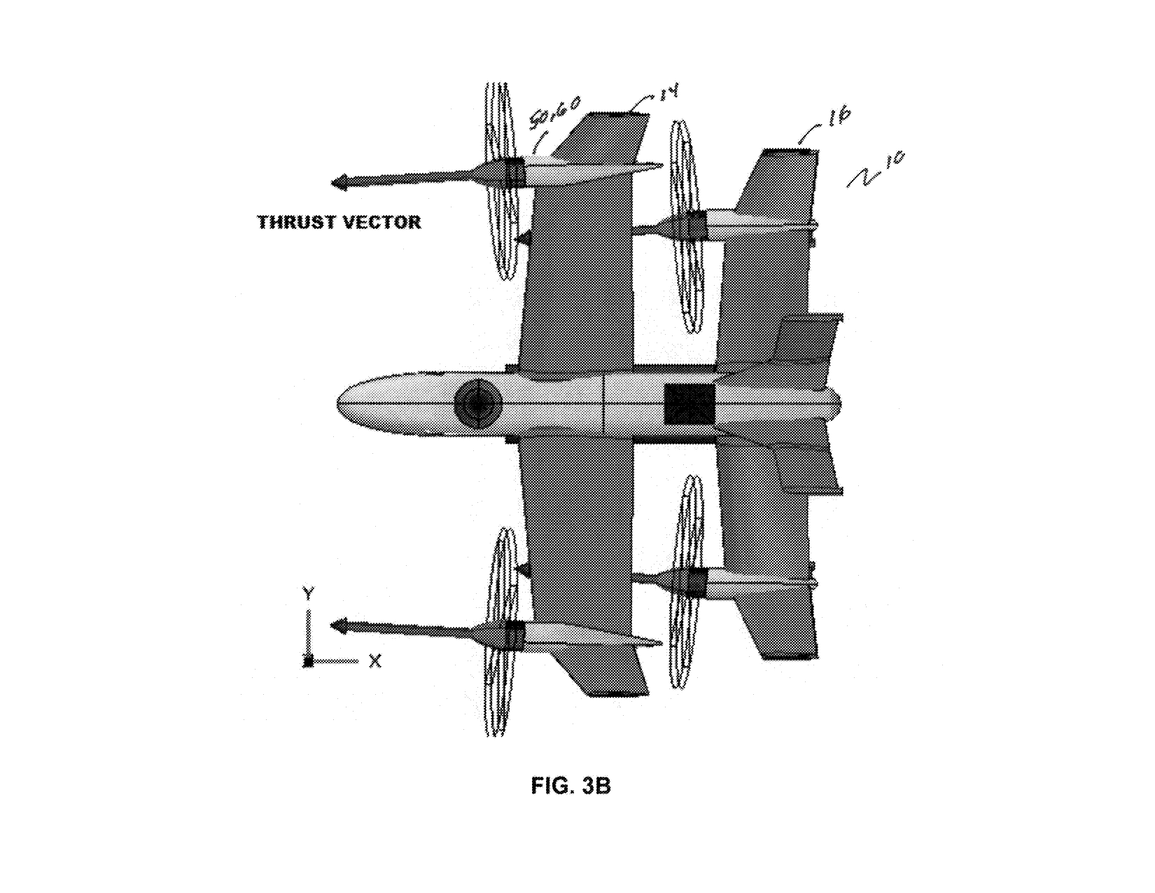

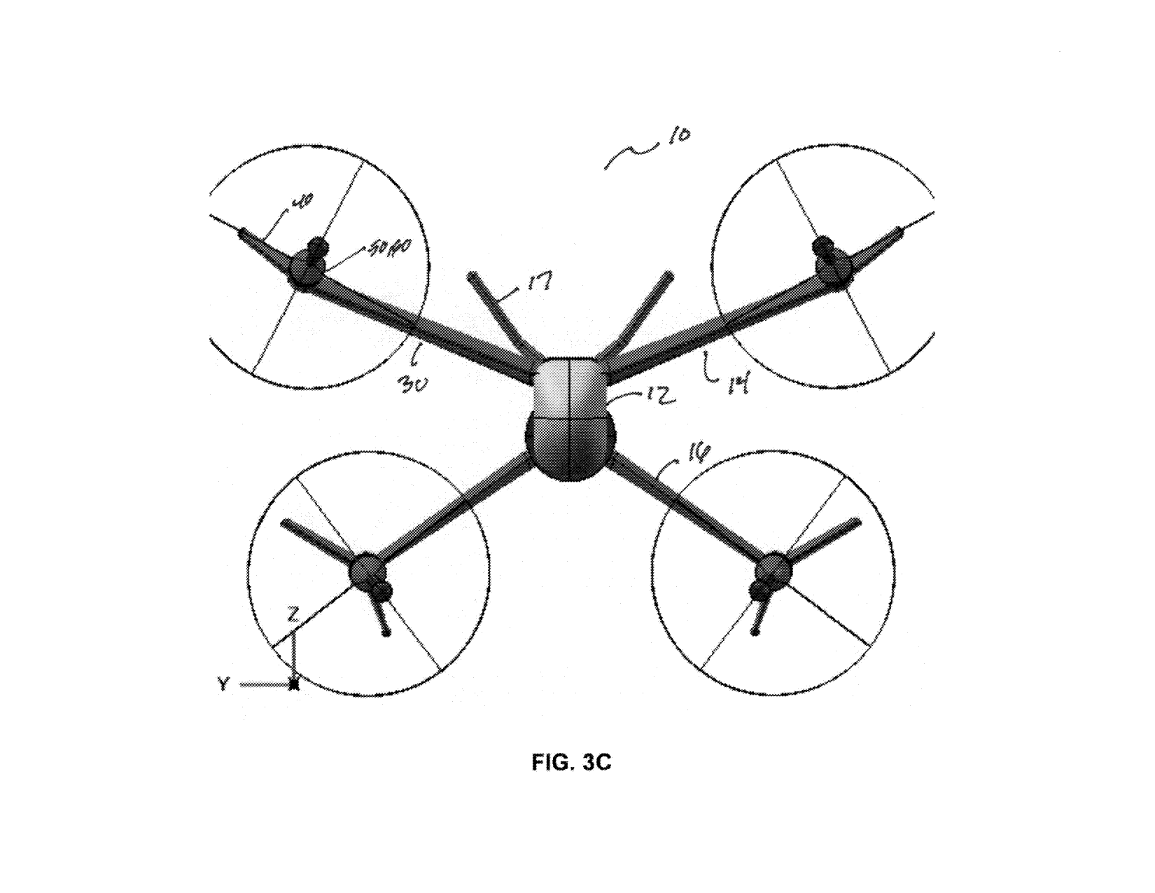

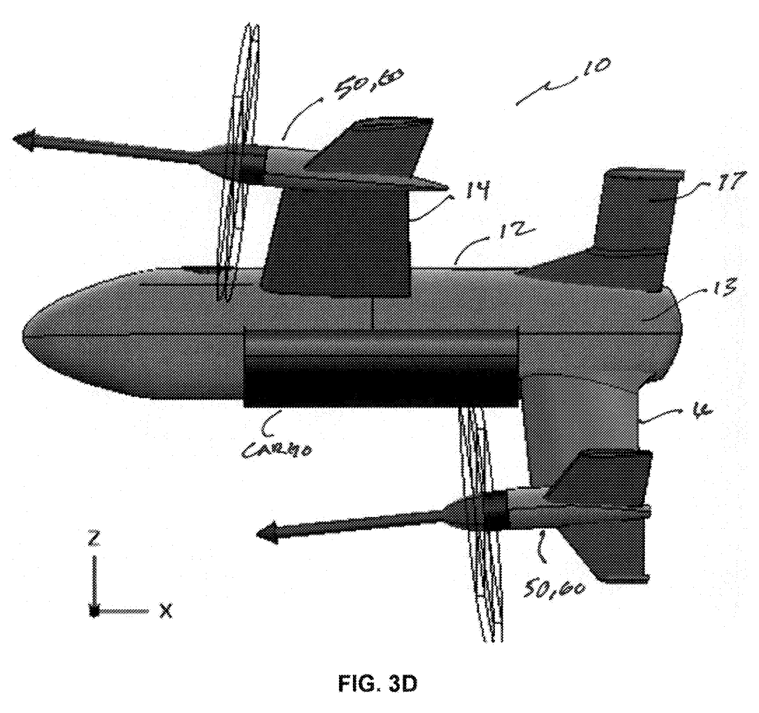

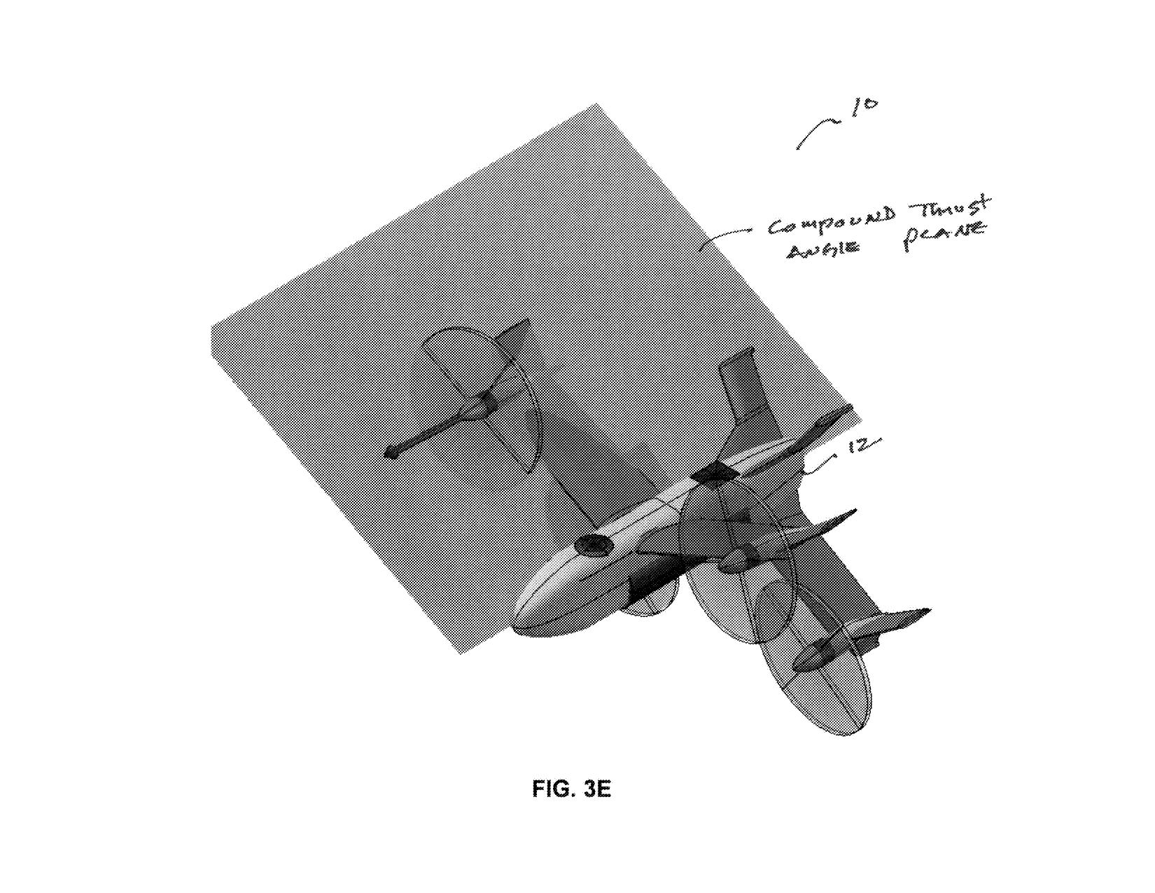

As shown in FIGS. 3A – 3E, each propulsion assemblies 60 is positioned therein the respective propulsion assembly pylon 50 of wing 14 such that the angle of thrust of each of the propulsion assemblies 60 forms a compound angle. As shown in the figures, the props of each propulsion assemblies 60 are tilted on two axis, with the thrust vector of each of the propulsion assemblies 60 on wing 14 being angled both inwardly at an acute angle toward a plane bisecting the XZ axis of the airframe and the CG and upwardly at an acute angle away from a plane bisecting the XY axis of the airframe and the CG. Similarly, the thrust vector of each of the propulsion assemblies 60 on wing 16 can be angled both inwardly at an acute angle toward a plane bisecting the XZ axis of the airframe and the CG and downwardly at an acute angle away from a plane bisecting the XY axis of the airframe and the CG. The respective acute angle can be between about 2 degrees and about 20 degrees, more preferably between about 4 degrees and about 10 degrees, and most preferred about 7 degrees. As one skilled in the art will appreciate, the compound angle of the generated thrust by the respective propulsion assemblies provides for increased sensitivity to applied torque generation of the thrust about the CG (X-axis) of the aircraft.

In embodiments, positioning the thrust vector of each propulsion assemblies 60 as described allow for an increase in yaw control authority of the aircraft, when in hover orientation, or roll control authority, when in forward flight orientation. As shown, the axis of rotation of each prop is rotated about an axis between the center of the prop and orthogonal to the roll axis 10a of the aircraft. It further allows for an increase in the yaw control authority. In this aspect, since the propulsion assemblies 60 on wing 14 are forward of the aircraft CG, they would be pitched downwardly to increase their pitch control authority. One will appreciate that the cross product of the relative forward location of propulsion assemblies 60 on wing 14 with the angle of the prop axis of rotation about the aircraft’s CG is greater than if the axis of rotation of the prop was parallel to the aircraft’s longitudinal axis. Similarly, the props of the propulsion assemblies 60 on wing 16 are positioned aft of the aircraft’s CG and are pitched down to increase their pitch control authority. The cross product of the props of the propulsion assemblies 60 on wing 16 location with the angle of the prop’s axis of rotation about the aircraft’s CG is greater than if the axis of rotation of the prop was parallel to the aircraft’s longitudinal axis.

Operationally, the propulsion assemblies 60 of the aircraft that are used to propel and control the aircraft 10 must be mounted well above and outboard of the airframe CG in order to enable differential throttles to generate desired level of torques on the airframe of the airframe of the aircraft. As one will appreciate, it is contemplated that electric motors of the propulsion assemblies 60 can be mounted within the propulsion assembly pylon 50.

One skilled in the art will also appreciate that the design of each of the wings 14, 16 incorporates taper, with longer cord lengths at the root of the respective wing and shorter chord lengths at the tips or distal ends of the respective wings. Referring to the figures, outboard of each prop centerline is a region of significant taper ratio in the wing 14, 16 design in order to help smooth out the spanwise lift distribution, while accounting for the swirl generated by the propeller. This reduces the induced drag of the aircraft, which enables the aircraft to achieve greater payload/range performance.

In described embodiments, each wing 14, 16 aids in maneuvering the aircraft 10 without conventional aerodynamic control surfaces. In operation, all flight control of the aircraft 10 must be performed using propulsive controls (differential thrust of the props of the respective propulsion assemblies 60). In operation, control of the aircraft 10 pitch and yaw axis can be controlled using differential thrust between selected propulsion assemblies 60 to generate the desired torque generation on the aircraft 10 to control the pitch and yaw axis of the aircraft. In operation, the described configuration of the aircraft 10 aerodynamically couples the lateral and the directional axes of the aircraft combined with employing left/right differential thrust to maneuver the aircraft in the horizontal plane.

For example, the described wing design of the aircraft 10 allows for this aircraft control process. For example, if the aircraft needs to generate left roll torque (e.g. to bank left, or to lower the left wing to react to a gust disturbance), the following process can be enabled. First, the right side propulsion assemblies 60 are controlled to throttle up and the left side propulsion assemblies 60 are controlled to throttle down. The resultant left vs right differential thrust will induce the aircraft 10 to yaw to the left, generating positive sideslip (i.e., positive beta) on the aircraft. Due to the design of the wings 14, 16, significant Rolling Moment due to Sideslip (C_{l_beta}) is generated, which creates strong stability in the aircraft’s lateral axis. The lateral axis stability induces a strong left rolling moment (left roll torque) on the aircraft. Thus, it has been found that the aircraft 10 can perform banked turns and can achieve a much tighter turning radius than it otherwise would be capable of without ailerons.

The respective dihedral design of wing 14 and the combination dihedral and anhedral design of wing 16 affect the amount of Rolling Moment due to Sideslip (C_{l_beta}) that can be generated by the aircraft. In the example discussed above, dihedral has the primary effect for generating C_{l_beta} because as the aircraft flies with sideslip, the local angle of attack of the respective right wings of the wings 14 and 16 becomes different than the respective left wings’ local angle of attack of the wings 14 and 16, which resultingly causes the right wing to generate a different amount of lift than the left wing. One will appreciate that the difference in lift on the left vs right wing generates roll torque on the aircraft.

As further shown in the figures, it is contemplated that the propulsion assemblies 60 on wing 14 are displaced farther outboard than the propulsion assemblies 60 on wing 16, which helps to reduce the induced drag of the aircraft 10 by increasing the wingspan and it lowers the effective dihedral angle of the wings 14, 16 so that the lift generated by the wings has a greater vertical component and smaller (non-lift producing) horizontal component.

As exemplarily described, electrical power can be supplied to the electric motors of the propulsion assemblies 60 from batteries carried by the airframe 12 via the communication network. Flight control system 110 is configured to communicates via the wired communication network of airframe 12 with electric motors of the propulsion assemblies 60. It is contemplated that the flight control system 110 can receive sensor data from and can send flight command information to the electric motors such that each propulsion assembly 60 can be individually and independently controlled and operated. For example, flight control system 110 can be configured to be operable to individually and independently control the speed and the magnitude of the thrust vector of each propulsion assembly 60.

In embodiments, the flight control system 110 can be configured to autonomously control some or all aspects of flight operation for aircraft 10. In optional aspects, the flight control system 110 can also be operable to communicate with remote systems, such as a ground station via a wireless communications protocol. The remote system can be operable to receive flight data from and provide commands to flight control system 110 to enable remote flight control over some or all aspects of flight operation for aircraft 10 while autonomous and/or remote operation of the aircraft 10 enables the aircraft 10 to perform unmanned operations for both military and commercial applications.

In one non-limiting example, the aircraft 10 can operate as a support aircraft. As shown, cargo depicted as a package can be secured within a cargo enclosure defined within the airframe 12 of the aircraft. In the illustrated exemplary implementation, cargo is depicted as a single package carried within the cargo enclosure. Preferably, the cargo can be coupled within the cargo enclosure by suitable means to prevent relative movement there between, thus protecting the cargo from damage and maintaining a stable CG for the aircraft 10.

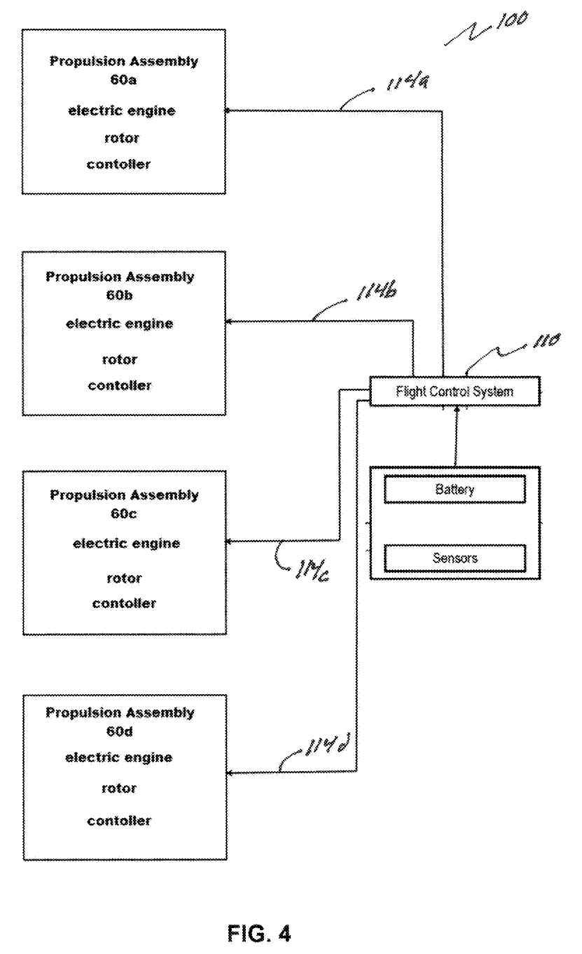

Referring next to FIG. 4, a block diagram illustrates one implementation of a thrust array and flight control system for an aircraft 100 that is representative of aircraft 10 discussed herein. Specifically, aircraft 100 includes four propulsion assemblies 60a, 60b, 60c, 60d that form a thrust array of thrust vectoring propulsion assemblies. Each propulsion assembly 60 includes a propulsion system herein as including an electric motor and a rotor assembly. The aircraft 100 further includes at least one controller, processor, sensors, and at least one power source (such as at least one battery).

A flight control system 110 is in operably communication with each of propulsion assemblies 60a, 60b, 60c, 60d by a communications network depicted as arrows 114a, 114b, 114c, 114d between the flight control system 110 and the propulsion assemblies 60a, 60b, 60c, 60d. The flight control system 110 is configured to receive sensor data and/or control data and to sends commands to the respective propulsion assemblies 60a, 60b, 60c, 60d to enable the flight control system 110 to independently control each of propulsion assemblies 60a, 60b, 60c, 60d as discussed herein.

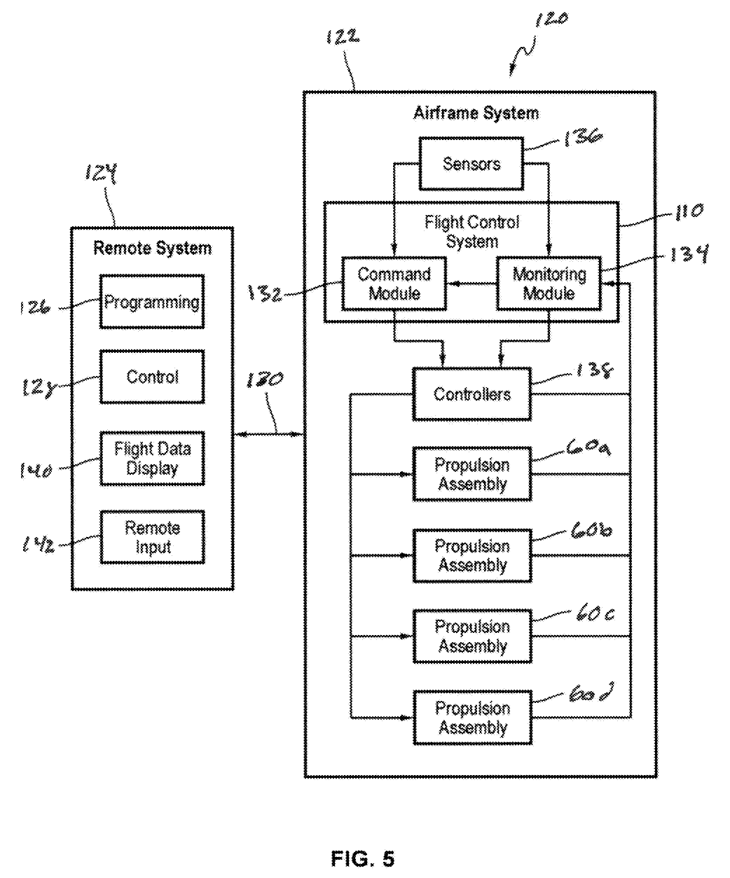

Referring additionally to FIG. 5, a block diagram depicts a control system 120 operable for use with aircraft 100 or aircraft 10 of the present disclosure. In the illustrated embodiment, the control system 120 can include two primary computer based subsystems; namely, an airframe system 122 and a remote system 124. In some implementations, the remote system 124 can include a programming application 126 and a remote control application 128. Programming application 126 can be configured to enable a user to provide a flight plan and mission information to aircraft 100 such that the flight control system 110 can engage in autonomous control over the aircraft 100. For example and without limitation, the programming application 126 can communicate with the flight control system 110 over a wired or wireless communication channel 130 to provide a flight plan including, for example, a starting point, a trail of waypoints and an ending point such that flight control system 110 can use waypoint navigation during the mission. In addition, the programming application 126 can provide one or more tasks to the flight control system 110 for the aircraft 100 to accomplish during the mission. Following programming, aircraft 100 can operate autonomously responsive to commands generated by flight control system 110.

The flight control system 110 preferably includes a non-transitory computer readable storage medium including a set of computer instructions executable by a processor. For example, the flight control system 110 can include one or more memory storage modules including, but is not limited to, internal storage memory such as random access memory, non-volatile memory such as read only memory, removable memory such as magnetic storage memory, optical storage, solid-state storage memory or other suitable memory storage entity. The flight control system 110 can be a microprocessor-based system operable to execute program code in the form of machine-executable instructions. In addition, flight control system 110 can be selectively connectable to other computer systems via a proprietary encrypted network, a public encrypted network, the Internet or other suitable communication network that can include both wired and wireless connections.

In the illustrated embodiment, the flight control system can include a command module 132 and a monitoring module 134. It is to be understood by those skilled in the art that these and other modules executed by the flight control system 110 can be implemented in a variety of forms including hardware, software, firmware, special purpose processors and combinations thereof. In operation, the flight control system 110 can be configured to receive input from a variety of sources including internal sources such as sensors 136, propulsion controllers 138 and propulsion assemblies 60a, 60b, 60c, 60d and external sources such as the remote system 124 as well as global positioning system satellites or other location positioning systems and the like.

For example, during the various operating modes of aircraft 100 including vertical takeoff and landing flight mode, hover flight mode, forward flight mode and transitions there between, the command module 132 can provide commands to propulsion controllers 138. These commands enable independent operation of each propulsion assembly 60a, 60b, 60c, 60d including rotor speed, magnitude of thrust vector and the like. The flight control system 110 can be configured to receive feedback from propulsion controllers 138 and each propulsion assembly 60a, 60b, 60c, 60d. This feedback is programmed to be processed by the monitoring module 134 that can supply correction data and other information to the command module 132 and/or propulsion controllers 138. It is further contemplated that sensors 136, such as positioning sensors, attitude sensors, speed sensors, environmental sensors, fuel sensors, temperature sensors, location sensors and the like can also provide information to the flight control system 110 to further enhance autonomous control capabilities.

As one will appreciate, some or all of the autonomous control capability of the flight control system 110 can be augmented or supplanted by remote flight control from, for example, a remote system 124. In this embodiment, the remote system 124 can include one or computing systems that can be implemented on general-purpose computers, special purpose computers or other machines with memory and processing capability. For example, the computing systems can include one or more memory storage modules including, but is not limited to, internal storage memory such as random access memory, non-volatile memory such as read only memory, removable memory such as magnetic storage memory, optical storage memory, solid-state storage memory or other suitable memory storage entity. The computing systems can be microprocessor-based systems operable to execute program code in the form of machine-executable instructions. In addition, the computing systems can be connected to other computer systems via a proprietary encrypted network, a public encrypted network, the Internet or other suitable communication network that can include both wired and wireless connections. The communication network can be a local area network, a wide area network, the Internet, or any other type of network that couples a plurality of computers to enable various modes of communication via network messages using as suitable communication techniques, such as transmission control protocol/internet protocol, file transfer protocol, hypertext transfer protocol, internet protocol security protocol, point-to-point tunneling protocol, secure sockets layer protocol or other suitable protocol., In operation, it is contemplated that the remote system124 can be configured to communicate with the flight control system 112 via a communication link 130 that can include both wired and wireless connections.

While operating in a remote control application 128, the remote system 124 can be configured to display information relating to one or more aircraft of the present disclosure on one or more flight data display devices 140. In this aspect, the display devices 140 can be configured in any suitable form, including, for example, liquid crystal displays, light emitting diode displays or any suitable type of display. The remote system 124 can also include audio output and input devices such as a microphone, speakers and/or an audio port allowing an operator to communicate with other operators or a base station. The display device 140 can also serve as a remote input device 142 if a touch screen display implementation is used, however, other remote input devices, such as a keyboard or joystick, can alternatively be used to allow an operator to provide control commands to an aircraft being operated responsive to remote control.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims.

What is claimed:

1. An aircraft operable to transition between thrust-borne lift in a VTOL configuration and wing-borne lift in a flight configuration, the aircraft comprising:
an airframe having a first wing and a second wing that are each configured to have an airfoil cross-section that generates lift responsive to the forward airspeed of the aircraft;
wherein each wing includes include a pair of propulsion assembly pylons, a root wing section, an inboard wing section, and an outboard wing section that are configured to increase the aerodynamic efficiency and flight dynamics of the aircraft, wherein the root wing section of each wing is coupled to and extends outwardly from the airframe to a distal end that is coupled to a proximal end of the inboard wing section, wherein the distal end of the inboard wing section is coupled to an inboard side of one propulsion assembly pylon and a proximal end of the outboard wing section is coupled to and extends outwardly from an outboard side of the propulsion assembly pylon, wherein the first wing and the second wing are positioned with respect to each other in a biplane orientation in which the first wing is positioned forward of the second wing that is positioned at a distal end portion of the airframe, and wherein the first wing forms an upper wing having a general dihedral configuration and the second wing forms a lower wing in which the inboard wing section has an anhedral configuration and the outboard wing section has a dihedral configuration; and
a plurality of variable speed electric propulsion assemblies having fixed pitch rotor blades and fixed thrust vector capability; wherein each propulsion assembly includes a rotor assembly that is coupled to an output drive of a respective electrical motor that rotates the rotor assembly in a rotational plane to generate thrust for the aircraft, and wherein each propulsion assembly is positioned therein a respective propulsion assembly pylon of the first and second wings such that the angle of thrust of each of the propulsion assemblies forms a compound angle.

2. The aircraft of claim 1, wherein the inboard wing section of the first wing is positioned at a dihedral angle A with respect to a plane parallel to the pitch axis of the aircraft, and wherein the dihedral angle A of the inboard wing section of the first wing is between about 15 degrees and about 25 degrees.

3. The aircraft of claim 2, wherein the dihedral angle A of the inboard wing section of the first wing is about 22 degrees.

4. The aircraft of claim 2, wherein the outboard wing section of the first wing is positioned at a dihedral angle B with respect to a plane parallel to the pitch axis of the aircraft, and wherein the dihedral angle B of the inboard wing section of the first wing is between about 35 degrees and about 45 degrees.

5. The aircraft of claim 4, wherein the dihedral angle B of the inboard wing section of the first wing is about 44 degrees.

6. The aircraft of claim 1, wherein the inboard wing section of the second wing is positioned at an anhedral angle C with respect to a plane parallel to the pitch axis of the aircraft, wherein the anhedral angle C of the inboard wing section of the second wing is between about -30 degrees and about -40 degrees.

7. The aircraft of claim 6, wherein the anhedral angle C of the inboard wing section of the second wing is about -30 degrees.

8. The aircraft of claim 6, wherein the outboard wing section of the second wing is positioned at a dihedral angle D with respect to a plane parallel to the pitch axis of the aircraft, and wherein the dihedral angle D of the inboard wing section of the second wing is between about 35 degrees and about 45 degrees.

9. The aircraft of claim 8, wherein the dihedral angle B of the inboard wing section of the second wing is about 44 degrees.

10. The aircraft of claim 1, further comprising a landing form coupled to and extending outwardly from each propulsion assembly pylon on the second wing at an anhedral angle E with respect to a plane parallel to the pitch axis of the aircraft.

11. The aircraft of claim 1, wherein the airframe further comprises two opposed vertical tails positioned thereon a distal portion of the airframe that are configured to improve directional stability at high angle of attack and are canted outboard relative to each other such that respective distal ends of the vertical tails are spaced farther apart than the respective proximal ends of the vertical tails.

12. The aircraft of claim 11, wherein the two vertical tails are configured to contain twist to help to increase directional stability while minimizing intersection drag at the airframe junction of the respective vertical tails.

13. The aircraft of claim 1, wherein the inboard wing section of the first wing has a sweep angle from a proximal end to a distal end of the inboard wing section of between about 2 degrees and about 5 degrees, and wherein the outboard wing section of the first wing has a sweep axis from a proximal end to a distal end of the outboard wing section of b5tween about 27.5 degrees and about 37.5 degrees.

14. The aircraft of claim 1, wherein the inboard wing section of the second wing has a sweep angle from a proximal end to a distal end of the inboard wing section of between about 5 degrees and about 10 degrees, and wherein the outboard wing section 40 of the second wing has a sweep axis from a proximal end to a distal end of the outboard wing section of between about 19 degrees and about 27 degrees.

15. The aircraft of claim 1, wherein the inboard wing section of the first wing has a taper ratio from a proximal end to a distal end of the inboard wing section of between about 0.78 and about 0.85, and wherein the outboard wing section of the first wing has a sweep axis from a proximal end to a distal end of the outboard wing section of b5tween about 0.60 and about 0.70.

16. The aircraft of claim 1, wherein the inboard wing section of the first wing has a local wing incidence (“”twist”) from the proximal end to the distal end of the inboard wing section that changes from about 4 degrees proximate the junction of the inboard wing section to the root section to about 1 degree at the junction of the distal end of the inboard wing section and the inboard side of a propulsion assembly pylon, and wherein the outboard wing section of the first wing twists from the proximal end to the distal end of the outboard wing section that changes from about 1 degrees proximate the junction of the proximal end of the outboard wing section to outboard side of the propulsion assembly pylon to about -4 degree at the distal end the outboard wing section.

17. The aircraft of claim 16, wherein the inboard wing section of the second wing has a twist from the proximal end to the distal end of the inboard wing section that changes from about 6 degrees proximate the junction of the inboard wing section to the root section to about -1 degree at the junction of the distal end of the inboard wing section and the inboard side of a propulsion assembly pylon, and wherein the outboard wing section of the second wing twists from the proximal end to the distal end of the outboard wing section that changes from about -1 degrees proximate the junction of the proximal end of the outboard wing section to outboard side of the propulsion assembly pylon to about -2 degree at the distal end the outboard wing section.

18. The aircraft of claim 16, wherein the first and second wings are configured to have a smooth progressively increasing region of separated airflow as the relative angle of attack (AoA) of the airframe increases.

19. The aircraft of claim 1, wherein the rotor assembly of each propulsion assemblies are tilted on two axis to generate increased sensitivity to applied torque generation of the thrust about the CG of the aircraft, and wherein the thrust vector of each of the propulsion assemblies on the first wing being angled both inwardly at an acute angle toward a plane bisecting the XZ axis of the airframe and the CG and upwardly at an acute angle away from a plane bisecting the XY axis of the airframe and the CG.

20. The aircraft of claim 19, wherein the thrust vector of each of the propulsion assemblies on the second wing can be angled both inwardly at an acute angle toward a plane bisecting the XZ axis of the airframe and the CG and downwardly at an acute angle away from a plane bisecting the XY axis of the airframe and the CG.

21. The aircraft of claim 20, wherein the acute angle can be between about 4 degrees and about 10 degrees.
